(19) United States
(12) Patent Application Publication
(10) Pub. No.: US 2009/0127192 A1
(43) Pub. Date: May 21, 2009

(54) Liquid-liquid extraction method and apparatus

(76) Inventor: John R. Troost, Roanoke, VA (US)

Correspondence Address: JOHN R. TROOST, 2427 CHATHAM RD., AKRON, OH, 44313, US

(21) Appl. No.: 11/986,251

(22) Filed: Nov. 20, 2007

(51) Int. Cl. B01D 11/04

(52) U.S. Cl. 210/634; 210/511

(57) ABSTRACT

A method and apparatus for extracting organic chemicals from water. In particular an apparatus and procedure to effect the liquid-liquid extraction of semi-volatile organic compounds from water in original sampling bottles by rotating a mixture of solvent(s) and/or solvent and salt with sample water for a prescribed period of time at a prescribed rate.

### TECHNICAL FIELD OF THE INVENTION

This invention relates in general to a method and apparatus for extracting organic chemicals from water. More specifically, the invention relates to an apparatus and procedure effecting the liquid-liquid extraction of semi volatile organic compounds from water in original sampling bottles.

### BACKGROUND OF THE INVENTION

Water is required to be sampled and tested routinely by environmental protection legislation as well as other concerns. Most organic analysis methods require removal of analytes from water by partitioning into an immiscible solvent, typically heavier than water, by a process known as liquid-liquid extraction. There are two common techniques.

The most labor intensive of these utilizes a separatory funnel whereby a water sample and an organic solvent are vigorously mixed and the liquid layers physically, visually separated. The mixing is often repeated with fresh solvent to maximize recovery. The separatory funnels may be shaken mechanically or by hand. Another technique, continuous liquid-liquid extraction makes use of an elaborate glass apparatus to automatic the extracting process. A heavier than water solvent (typically methylene chloride—DCM) is boiled and vaporized up into a cold water jacket. Re-liquidified solvent drops into a vessel containing the water sample and the solvent is recycled. The initial process generally takes 18 to 24 hours and is most often repeated by a second extraction of 18 to 24 hours after altering the pH of the water sample.

With a fairly new technique, organic compounds may also be removed from water by passing the water through a solid sorbent material from which the pollutants may subsequently be dislodged with solvent or a mixture of solvents.

With these procedures the solvent extract is generally reduced in volume by evaporation to enable the extracted organic compounds to be detected at lower levels. All of these processes are labor intensive, costly and/or time-consuming. An alternative is desirable.

A simple approach has been discovered with distinct advantages. Solvent (or a mixture of solvents) or solvent and salt may be added directly to water in sample bottles (those used to collect, transport and store water samples) to effect the extraction of semi volatile organics constituents with equal or enhanced efficiency as those commonly employed processed noted above. By turning the bottles horizontally on rails (on an apparatus designed specifically for this purpose) for one or more 12 hour periods, the specifications for a number of common environmental methods are achieved for a comprehensive array of important environmental pollutants with a minimum of labor and expense.

### SUMMARY OF THE INVENTION

The invention is a method and apparatus to be utilized as a cost effective alternative to replace current procedures for extracting semi-volatile organic chemicals from water.

As with any of the extraction procedures, as required by the method employed and the particular group of semi-volatile organic compounds that are targeted for analysis, the pH of the water in the original glass sample container is first checked and/or adjusted. Next, 100 mL of a solvent, solvent mix or approximately 200 g of sodium chloride and a solvent are added directly to the original sample bottle. A portion of the water in the bottle is removed to accommodate the solvent and/or salt.

In accordance with the invention, the bottle, with separate water and solvent layers (either heavier or lighter than water), is placed horizontally on a rack of parallel rods mechanically synchronized to turn at a rate of 12 revolutions per minute. The bottle is subsequently rotated for typically a twelve-hour period. The solvent layer is removed by transferring the entire bottle contents to a conventional separatory funnel or by attaching a clear tube and stopcock directly to the bottle. Again, depending on the method employed and the targeted analytes, the water is returned to the original container and “changed over” from acid to base or base to acid, additional solvent (slightly less volume than that used for the first 12 hour turn) is added and the bottle is rotated for a second 12-hour period.

This “in-situ” bottle extraction has the obvious advantages of reduced labor, solvent usage and overall cost while maintaining accuracy and likely improving precision. It is faster than continuous liquid-liquid extraction.

The technique is intended to be used as a substitute to the following environmental sample preparation methods: United States Environmental Protection Agency (USEPA), Office of Solid Waste, SW-846 Methods 3510C and 3520C. It has been demonstrated to meet or exceed the water analysis requirements of environmental methods 8270C, 8081A, 8151A, 625, 608, and 615.

The foregoing has outlined broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the claims of the invention.

### BRIEF DESCRIPTION OF THE DRAWINGS

For a more complete understanding of this invention and the advantages thereof, reference is made to the following descriptions taken in conjunction with the accompanying drawings in which:

FIG. 1 is a diagrammatic view of one embodiment of a bottle rotating device; and

FIG. 2 is a diagrammatic view of one embodiment of a bottle cap adaptor to enable the bottle to act as a separatory funnel to replicate the function of visually separating two liquid layers.

### DETAILED DESCRIPTION OF THE INVENTION

The present invention can significantly reduce the cost, labor, materials and time required to perform liquid-liquid extractions.

Water extractions are currently performed by separatory funnel, continuous liquid-liquid extraction or by solid phase adsorption. A number of USEPA environmental analysis methods (SW-846 Methods 3510C, 3520C, 8270C, 8151A, 8081A, 8082A as well as 525, 625, 608, 615, etc.) provide procedures for extracting large groups of target analytes of regulatory concern. The extraction procedures make use of various apparatus such as the aforementioned separatory funnels, continuous liquid-liquid extractors and vacuum filtration devices.

With most of these methods, the pH of the water is carefully adjusted to enhance the recovery of phenols, amines and other pH sensitive species, to prevent unwanted reactions, or to help remove unwanted co-extracted material. A salt is added to the water with some of the methods to aide the extraction process. More than one step is generally involved. For herbicides (Method 8151A) for instance, a water sample is first treated with strong base to convert herbicide esters to the water-soluble acid forms. The water is then mixed with an organic solvent to enable interfering material to be concentrated in the solvent and subsequently discarded. This step thus serves as a “clean-up.” After the clean-up step the pH of the sample water is lowered to <2 by the addition of a strong acid. Diethyl ether, a lighter than water solvent, is added and the two immiscible liquids are vigorously mixed.

If a separatory funnel is used, the ether and water are intermixed by hand or with the help of a mechanical shaker for a period of two minutes or more. The water is drained off and retained. The ether (top layer), containing herbicides extracted out of the water, is collected in another vessel.

Method 8151A calls for returning the water to the separatory funnel and repeating the extraction by adding a second volume of ether with an additional two minute vigorous shake. The ether layer is drained off and comingled with the first ether extract. A third and final extraction is performed in like fashion. The combined ether extracts are subsequently concentrated to a small volume by evaporation.

The overall procedure is very effective in enabling a wide variety of chlorinated phenoxy acid herbicides to be recovered from water with high yield (>70% recovery) but the procedure is labor intensive.

Methods 625 and 8270C target a wide range of semi-volatile organic compounds, neutral, acidic and basic, requiring separate extractions at low and high pH using a heavier than water solvent (methylene chloride—DCM). If separatory funnel extractions (Method 3510C) are performed for these methods, six (6) separate, two-minute mixing sessions are needed.

With the vigorous mixing inherent with the separatory funnel extraction technique, the formation of emulsions between the water and solvent layer are an all too common occurrence. These can make the separation of the solvent from the water difficult rendering the overall procedure ineffective if not entirely futile.

If a continuous liquid-liquid extraction apparatus (Method 3520C) is utilized, a volume of DCM is boiled up into a cold water jacket and allowed to continually condense drop wise through a pH adjusted water sample housed in a glass chamber for an 18 to 24 hour period of time. Expensive glassware is required as well as heating mantels and cold water condensing jackets. The glassware is difficult to clean and is easily broken.

Adsorbent discs may also be employed whereby the water sample is passed through a solid phase sorbent material after pH adjustment using gravity and/or vacuum force. Solvents are used to dislodge targeted compounds from the sorbent bed. The sorbent materials available restrict the applicability of the procedure while particulate matter in the water can foul the filtration. The filtration procedure requires careful attendance and the sorbent discs and vacuum equipment can be expensive.

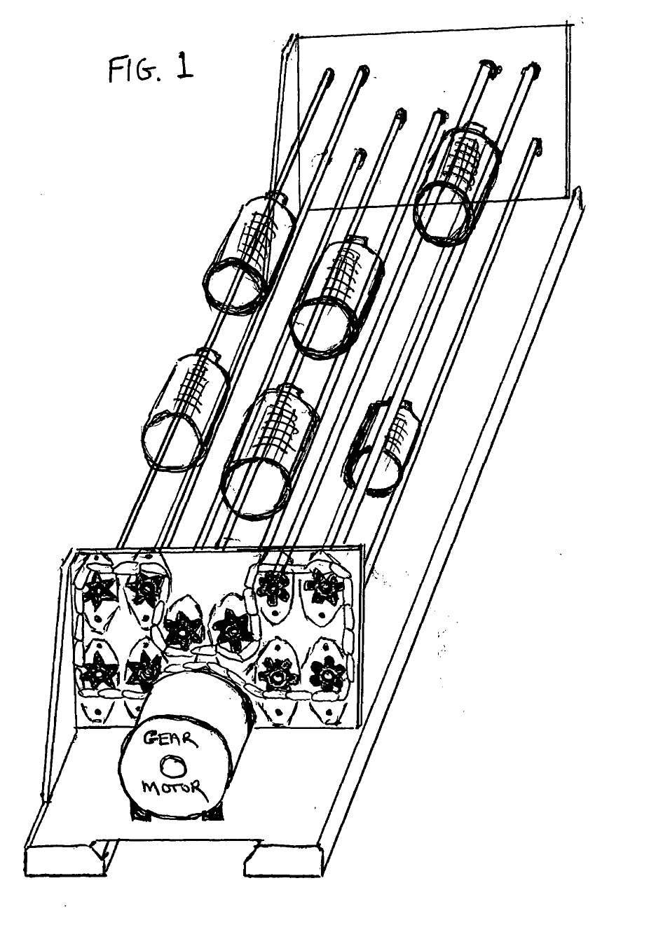

In accordance with this invention, liquid-liquid extractions are able to be performed in the same bottles in which samples are collected by the addition of solvent(s) followed by turning of the bottles, horizontally, on a rack at a prescribed rate of rotation for a prescribed amount of time. FIG. 1 is a preferred embodiment of a multi-bottle rotation device designed and tested specifically for the application of this invention. Five (5) sets of ⅞″×5′ long galvanized rods spaced three inches apart serve to turn thirty (30) or more average sized (! Liter) bottles (the size routinely used to collect environmental water samples) at 12 rpm. The rods are housed in bearings and are synchronized to turn in unison by chain and sprocket and a ¾ hp gear motor.

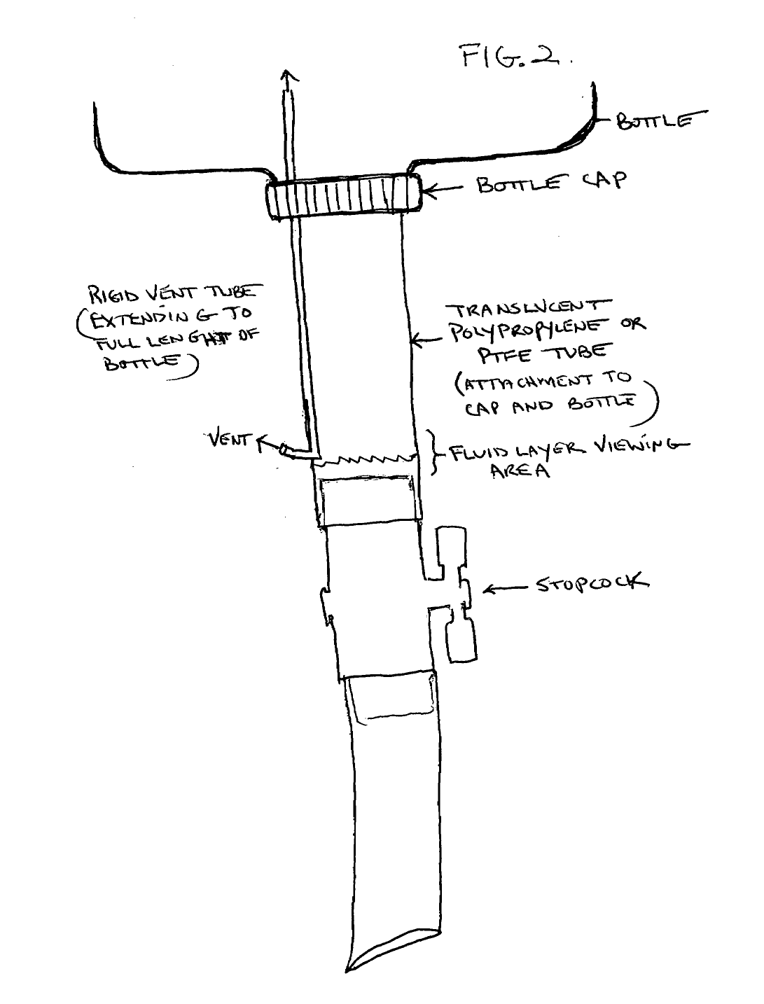

Water samples collected in 1 liter bottles are extracted in the original container. Up to 200 mL of the sample water is first removed to accommodate the addition extracting solvent. The level of approximately 800 mL of water remaining in the bottle is marked (to later measure the exact volume to be extracted) or the weight of the entire container is recorded. Generally, for all extraction techniques, the pH of the water is adjusted according to the method being performed and approximately 100 mL of solvent (or a solvent mix) is added. The bottles are recapped (standard Teflon lined caps are sufficient) and laid on their side on the rotation rack apparatus. A single 12-hour turn is performed. Solvents are collected directly from the bottles using a bottle cap attachment (FIG. 2 enabling the bottles to be used directly to perform the visual phase separation function of a separatory funnel. Alternatively, the contents of the bottle may be transferred to a traditional separatory funnel to effect the separation of the liquid layers.

The solvent layer is collected in a smaller bottle and 10 g or more of sodium sulfate may be added directly to the solvent to adsorb any residual water. (After shaking, following at least a two-hour period of time, the sodium sulfate should remain free flowing. If the sodium sulfate forms a clump, additional sodium sulfate is added until it remains free flowing.)

If the method calls for an additional extraction at an alternate pH (change-over from acid to base or base to acid), the once-extracted water is readjusted with strong acid or base and an additional aliquot of solvent (less volume than the first extraction), usually 80 mL, is added and a second 12 hour turn is performed.

### Invention Specific Procedure—Method 8151A (Chlorinated Phenoxyacetic Acid Herbicides)

Remove up to 300 mL from 1 liter sample bottle. Mark water level. Add approximately 180 g sodium chloride and 12 mL of 6N NaOH. Shake to dissolve the salt. Spike field samples and QC samples with surrogates and fortification solutions as appropriate. Place bottle on rack and allow to turn at 12 rpm for one (1) hour. Add 120 mL of methylene chloride (DCM) and rotate for an additional four (4) hours. (It is not necessary to vent pressure). Discard the methylene chloride layer.

Adjust pH of remaining water to <2 with 12 mL of 12N H₂SO₄, add 120 mL of diethyl ether and turn for 12 hours. Retain ether layer (add 10 g of acidified sodium sulfate to retained ether). Add an additional 80 mL of diethyl ether to the water and turn a second time for 12 hours. Collect diethyl ether combining with the solvent of the first extraction. Allow sodium sulfate to remain in contact with the solvent for at least two hours. If the sodium sulfate does not remain free-flowing, add more). Concentrate the solvent and derivatize as normal.

NOTES: With the above procedure five Appendix IX herbicides studied (2,4-D, Pentachlorophenol, Silvex, 2,4,5-T and Dinoseb) are extracted with an average recovery of 91% (low 75%,-2,4,5-T). The procedure saves much labor and effort is inherently more precise than the conventional technique. Up to thirty extractions may be performed simultaneously. The extracting vessel is disposable and the extracted water may be readily retained if desired.

### Invention Specific Procedure—Method 625 (Semi-Volatile Organics Compounds—All Method Analytes)

Remove up to 250 mL from 1 liter sample bottle. Mark water level. Change pH of water to <2 with approximately 4 mL of 12N H₂SO₄ Spike field samples and QC samples with surrogates and fortification solutions as appropriate. Add a mixture of 60 mL DCM/40 mL diethyl ether. Place bottle on the rotation rack and allow to turn at 12 rpm for twelve (12) hours. Remove and retain the heavier than water DCM/ether solvent layer (add 10 g of acidified sodium sulfate to the solvent and shake to mix). (A small glass Boston round bottle (200 mL) serves well to collect the solvent layer. This bottle is easily cleaned and may be reused if desired).

Dissolve 180 g of baked, reagent grade sodium chloride into the remaining acidic water by shaking. Change over the pH of the water to >12 by adding approximately 12 mL of 6N NaOH. Add 80 mL of the DCM/ether mix (50 mL DCM/30 mL ether) and turn on the rotation rack for another 12-hour period. Combine the second solvent layer with the first, concentrate conventionally and analyze.

NOTES: With the above procedure all Method 625 analytes were extracted with an average recovery of 80% (low 36%,—N-Nitrosodimethylamine). While Method 625 calls for a base/neutral extraction first followed by an acid extraction, indisputably better results where obtained with the acid first extraction procedure as described. The recovery requirements (Method 625, Table 6) for each and every method analyte are comfortably achieved.

The addition of the salt may be eliminated to simplify the procedure further but the recovery for N-Nitrosodimethylamine has been shown to degrade somewhat further. Some, if not much of this, the most volatile 625 analyte may be lost during the evaporative concentration of the extract solvent. Pure DCM may be substituted for the DCM/diethyl ether mix but phenol recovery degrades from approximately 67% to approximately 27%. Using amber bottles to extract, the recovery for the light sensitive 625 analyte, hexachlorocyclopentadiene can exceed 75%.

Since some of the sample volume must be removed to make room for the addition of solvent, the reporting limits will be slightly higher than usual. To compensate for this, instrument calibrations may be extended to lower levels or the final extract volume may be reduced.

### Invention Specific Procedure—Method 8270C (Semi-Volatile Organics Compounds—140Method Analytes Including all Appendix IX Compounds Normally Analyzed by Method 8270C)

Remove up to 200 mL from 1 liter sample bottle. Mark water level. Change pH of water to <2 with approximately 4 mL of 12N H₂SO₄ Spike field samples and QC samples with surrogates and fortification solutions as appropriate. Add a mixture of 60 mL methylene chloride/40 mL diethyl ether. Place bottle on the rotation rack and allow to turn at 12 rpm for twelve (12) hours. Remove and retain the heavier than water DCM/ether solvent layer (add 10 g of acidified sodium sulfate to the solvent and shake to mix).

Change over the pH of the water to >12 by adding approximately 12 mL of 6N NaOH. Add 80 mL of the DCM/ether mix (50 mL DCM/30 mL ether) and turn on the rotation rack for another 12 hour period. Combine the second solvent layer with the first, concentrate conventionally and analyze.

NOTES: With the above procedure 140 method analytes studied were extracted with an average recovery of 85%. Two low recoveries, 1,4-Phenyleneamine (7%) and Resorcinol (11%) were also found to be recovered low using conventional separatory and continuous liquid-liquid techniques. The invention technique fared no better or worse for these troublesome species. If required to be analyzed for, the recovery for pyridine (normally 25%) may be doubled by adding salt to the second, basic extraction as above for Method 625.

As high or higher yields are obtained with the invention procedure compared to those obtained using conventional continuous liquid-liquid extraction equipment. Precision is markedly improved because the variables in the procedure are readily controlled. The invention technique uses much less solvent and is faster than continuous liquid-liquid extraction. Emulsions, the bane of the separatory funnel technique are non-

The labor required to conduct the invention procedure is greatly reduced.

### Invention Specific Procedure—Other Semi-volatile Organic Methods

Pesticides, PCBs, Total Petroleum Hydrocarbons are also readily extracted with high yield following the 8270C invention procedure at a neutral pH using pure DCM as the extracting solvent. Neither ether nor salt is necessary. Though untested, it is suspected that this method may be used in place of any procedure calling for liquid-liquid extraction.

What is claimed is:

1. A method of extracting organic chemicals from water comprising the steps of adding solvent(s) and salt(s) to water in bottles, to include original sampling containers, followed by rotation of the bottles on an apparatus designed to turn the bottles at a prescribed rate for a prescribed period of time.

2. An apparatus for rotating the bottles to conduct the method of claim 1, said apparatus comprising a rack of rollers or a rack of parallel rods mechanically synchronized to support and rotate bottles at a prescribed rate.

3. A bottle cap or bottle cap attachment to connect a stopcock or valve to a bottle to enable the bottles of the function of claim 1 to perform the separation of liquid phases function normally performed by a separatory funnel. A preferred embodiment of the bottle cap or bottle cap attachment comprises:
a) A tube attached directly to a bottle cap or a tube fashioned with a rim to seal to a bottle cap having an open hole. Said tube being made of polypropylene, polytetrafluoroethylene, glass or any other clear or translucent material.
b) A vent tube or other mechanism serving to maintain pressure equilibrium while the bottles performing the method of claim 1, equipped with a tube and stopcock are used to separate liquid phases.
